(19) United States
(12) Patent Application Publication
(10) Pub. No.: US 2026/0253014 A1
(43) Pub. Date: Aug. 27, 2026

(54) Automated Knowledge Documentation of Key Performance Indicators

(71) Applicant: International Business Machines Corporation, Armonk, NY (US)

(72) Inventors: Nianjun Zhou, Chappaqua, NY (US); Dhavalkumar C. Patel, White Plains, NY (US); Shuxin Lin, White Plains, NY (US); Fearghal O'Donncha, Aran Islands (IE)

(21) Appl. No.: 19/059,492

(22) Filed: Feb. 21, 2025

(51) Int. Cl. G06Q 10/0639; G06F 40/169; G06F 40/226; G06F 40/30

(52) U.S. Cl. CPC G06Q 10/06393; G06F 40/169; G06F 40/226; G06F 40/30

(57) ABSTRACT

An approach for automated documentation of key performance indicators. The approach presented herein may include incorporating domain understanding of an asset with a hierarchy into a large language model. The approach may also include translating the domain understanding into a plurality of multi-turn questions annotated with the asset profile utilizing the large language model. The approach may further include generating one or more long-form knowledge documents, based on the multi-turn questions, wherein the one or more long-form knowledge documents comprise key performance indicators for the asset. The approach may include validating the long-form knowledge document, utilizing a natural language inferencing model. Furthermore, the validated large form knowledge document may consist of steps of generating calculation code and synthetic data.

### BACKGROUND

The present invention relates to industrial asset management, and more specifically, to monitoring assets via key performance indicators.

Industrial Asset Management, in addition to the low level of IoT metrics, relies heavily on top level Key Performance Indicators (KPIs) that capture the current status of an asset, as well as its historical performance. Such a top level of KPIs encapsulates a low level of operation data and makes it easy to be digested for decision support. Monitoring these assets involves tracking various KPIs that measure operational efficiency, health, and performance. This process is crucial for organizations to make informed decisions about maintenance schedules, resource allocation, retirement, replacement, and overall business strategy. However, traditionally, domain experts require manual input to define relevant KPIs, asset components, sensors/meters, and calculation methodologies.

This manual process is often time-consuming, expensive, and subject to limitation of individual human knowledge level, leading to inaccurate or incomplete insights for actionable and insightful KPIs. To address these challenges, companies are actively seeking ways to streamline the monitoring of industrial assets, particularly when it comes to inputting asset specifications and defining relevant KPIs for various asset classes. Deriving long-form, factually accurate, and comprehensive insights from industrial asset data using existing solutions can be a complex task that poses significant challenges. As a result, developing efficient solutions for assessing KPIs across different assets is crucial for effective industrial asset management. This includes leveraging technologies like artificial intelligence, machine learning, and automation to minimize manual intervention and maximize efficiency, relevance, and completeness. By doing so, organizations can unlock the full potential of their industrial assets, optimize performance, and ultimately drive business growth.

### SUMMARY

According to an embodiment of the present invention a computer-implemented method, computer system, and computer program product for automated documentation of key performance indicators may be disclosed. which may include: incorporating domain understanding of an asset with a hierarchy into a large language model; translating the domain understanding into a plurality of multi-turn questions annotated with the an asset profile utilizing the large language model; generating one or more long-form knowledge documents, based on the multi-turn questions, wherein the one or more long-form knowledge documents include key performance indicators for the asset; and validating the one or more long-form knowledge documents, utilizing a natural language inferencing model.

### BRIEF DESCRIPTION OF THE DRAWINGS

FIG. 1, is a block diagram depicting an exemplary computing environment for automated knowledge documentation of key performance indicators, in accordance with an embodiment of the invention

FIG. 2A, is a block diagram depicting a system for automated knowledge documentation of key performance indicators in industrial asset management, in accordance with an embodiment of the invention.

FIG. 2B, is a block diagram depicting an automated knowledge documentation engine, in accordance with an embodiment of the invention.

FIG. 3, is a flowchart, depicting the steps of generating and validating automated documentation of key performance indicators.

### DETAILED DESCRIPTION

Embodiments of the present invention recognize the advantages of developing efficient solutions for assessing KPIs across different assets is crucial for effective asset management. This includes leveraging technologies like artificial intelligence, machine learning, and automation to minimize manual intervention and maximize efficiency, relevance, and completeness. By doing so, organizations can unlock the full potential of their industrial assets, optimize performance, and ultimately drive business growth.

Asset Management relies heavily on Key Performance Indicators (KPIs) that capture the current status of an asset, as well as its historical performance. Monitoring these assets involves tracking various KPIs that measure operational efficiency, health, and performance. This process is crucial for organizations to make informed decisions about maintenance schedules, resource allocation, and overall business strategy. However, traditionally, domain experts require manual input to define relevant KPIs, components, sensors/meters, and calculation methodologies.

With the advancement of large language models (LLMs), they have accumulated knowledge that surpasses individual domain experts and encompass vast information about assets of the same type operating in diverse environments across different clients, beyond a single organization. In addition, the natural language interface enables easy interaction. That provide an opportunity to gather insights more comprehensively and efficiently. However, the challenge remains in extracting this knowledge more relevant and actionable.

Current Limitations of LLMs are that they only understand the high-level of KPI concepts. They are lacking linkages to the real data level metrics involving lower level work orders, sensors, and meters for the components composing the asset. Therefore, there is a dependency on domain expertise that is only available via subject matter experts. Existing systems for asset monitoring and KPI calculation often require your invaluable expertise to design the KPIs and metrics manually. It goes without saying, creating solution recipes tailored to specific asset classes can be a lengthy process that involves synthesizing data from various components and sensors/meters. While some solutions use machine learning and data analysis, generating guided prompts and validating knowledge documents remains manual, leading to inefficiencies and potential inaccuracies. Meanwhile, automated systems like LLMs sometimes produce responses that need more efficiency, and completeness, and even factual accuracy, making it difficult to rely on them for complex industrial applications.

To further that, industries and associated businesses rely on assets (e.g., turbines, transformers, condensers, compressors, etc. . . . ). Decisions associated with said assets utilize key performance indicators to make those decisions. Decisions may include halting operation of an asset, inspect an asset, perform general maintenance on an asset, repair a broken or damaged asset, replace an asset and/or retire an asset. The KPIs (e.g., performance efficiency, reliability, criticality, health, and sustainability, or key metrics (e.g., anomaly prediction, failure prediction, energy loss estimation, greenhouse gas emissions, reusable lifetime, power usage, etc. . . . ) can be aggregated through operation monitoring, failure states, or operation modes, which are supported by asset sensors, output or input sampling, asset inspection and historical records. The KPIs or key metrics can be predicted or estimated by machine learning models or engineering models developed or trained with asset sensors, output or input sampling, asset inspection and historical records.

In an embodiment there is an automated framework for KPI knowledge extraction. The automated framework can designed to create a tailored solution for assets in an industrial setting. The embodiment may include an automated LLM prompt generation pipeline to guide the process of extracting asset knowledge for selected KPU from a large language model. Furthermore, the embodiment may include a multi-turn question and answer combination based on an agentic style framework for generating long-form knowledge documents, using the extracted knowledge. Such an agentic style helps maintain the consistency of extracted knowledge from the multi-turn question-and-answer interactions. An agentic style framework or architecture is Agentic AI architecture is a design approach where artificial intelligence (AI) systems function as autonomous agents capable of achieving specific goals independently. These agents interact with their environment, use tools and collaborate with other agents to perform tasks. Using Agentic AI tasks that once took hours of manual work can now be completed in a matter of seconds or less. This enables stakeholders to focus on developing strategies and optimizing performance while advanced AI-machine learning algorithms handle the heavy lifting of data analysis and decision support. To levigate the potential hallucination from LLM and increasing the relevancy of the extracted knowledge, there may also be a validation pipeline for validating the long-form knowledge document, based on natural language inference.

An embodiment of the present invention may include a method for knowledge extraction regarding an industrial asset and the industrial assets KPIs from a large language model. The knowledge may be extracted via a sequence of interconnected questions. The interconnected questions may be generated based on a knowledge graph that guilds to generate the multi-turn question and answer process. This can be an iterative process in which the answers from the previous round are fed back into the LLM. This structured process allows for the extraction of the knowledge via an exploration of the LLMs knowledge base. For example, guided knowledge extraction may employ a knowledge taxonomy graph to auto-generate questions to extract knowledge in a control manner. This may steer the extracted knowledge process towards predefined knowledge domains to align the knowledge towards predefined guidelines associated with the industrial asset.

In an embodiment, the implementation of the invention includes a KPI taxonomy to prompt task which generates a prompt sequence via an LLM in the following manner illustrated in table 1 for a specific KPI, such as the knowledge extraction for industrial asset health

TABLE 1
KPITaxo2Prompt: Generate PromptSequence

```
  Task description: Come up with a short plan to generate knowledge
document industrial asset health KPIs for {asset type, brand, or operational
environment} ....
  Taxonomy Intro [parent] is [relation] by [child]
  Materialized Taxonomy: Here is the asset health taxonomy.
      Asset health is the root node
      Asset health is analyzed by asset health its component
      Asset health is analyzed by asset historical record of asset
management
      Asset health is analyzed by the asset profile, such as vendor, brand
and year of built
      ...
  Goal: Calculate asset health using component health
  Think: Identify all the important components of the asset;
  Think: My target is the component
    Step 1: Let us focus on the component-based asset health. ...factors
      coming from the 1. Mechanical, 2. Electrical ...
  Think: Now, 1 will traverse the taxonomy for each child node ...
    Step 2: Let us focus on the Mechanical issue ...
    Step 3: let us focus on the Electrical issue ...
      ...
  Think: ... Let us be more specific for an asset class (dynamic feed into
the think part).
    Step X: ...
```

In an embodiment, given the PromptSequence, a guided pipeline, the first task to execute is generating the knowledge document. In the embodiment, define five distinct approaches to create outputs using PromptSequence. Each approach defines its unique way of utilizing multi-turn questions to communicate with the LLM. The five approaches are 1. Last Question (Last_{Q}): Only the last question in PromptSequence is executed to capture the Zero-shot capability of LLM as a baseline. It mimics the simplest case of asking LLM directly for knowledge extraction 2. All Questions Concatenated (All_{Q}): combine all questions from PromptSequence into one extended query, testing the effect of presenting the full question context in a single prompt. 3. All Questions with Chain of Thought (All_{QCOT}): This method enhances the All_{Q} approach by incorporating a “think step-by-step” comment at the end of the last question in the prompt. 4. All Questions with ReAct (All_{QREACT}): This method enhances the ALL_{Q} approach by incorporating a ReAct agent that enables LLM to think, act, and observe each question in PromptSequence before answering the last question. 5. Guided Iterative Thought (GIT_{Q}): This approach simulates a dynamic Q/A session, where each question and its subsequent answer lead to the following query, mirroring a real-world interaction pattern. In this process, questions are already generated in PromptSequence and its answers help to understand how the final knowledge is generated.

An embodiment of the invention may include a system for asset management. The asset management may be based on one or more KPIs. KPIs can also encompass key metrics. KPIs can include, but are not limited to, a health score, a sustainability score, an asset reliability score, maintenance costs, asset availability, performance efficiency, a reliability score, and a criticality score. Those KPIs are typical generic to all the industrial asset. A health score reflects the current condition and performance of an asset. A sustainability score evaluates the environmental sustainability of asset operation, asset reliability measures the frequency an asset functions without a failure. Maintenance costs tracks the costs associated with maintaining an asset. Asset availability is the proportion of time which the asset is operational and available for use. Performance efficiency assesses the operational effectiveness of an asset. A reliability score indicates the dependability of an asset over time. A criticality score assesses the importance of an asset to overall operations of an enterprise.

An embodiment may be able to ensure completeness of a long-form knowledge document via validating the document. For example, the embodiment may compare returned answers to articles and other documents to detect gaps an inconsistencies. Further, based on any identified gaps or inconsistencies, the embodiment may generate additional questions from the multi-turn question and answer framework to address the identified gaps or inconsistencies.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

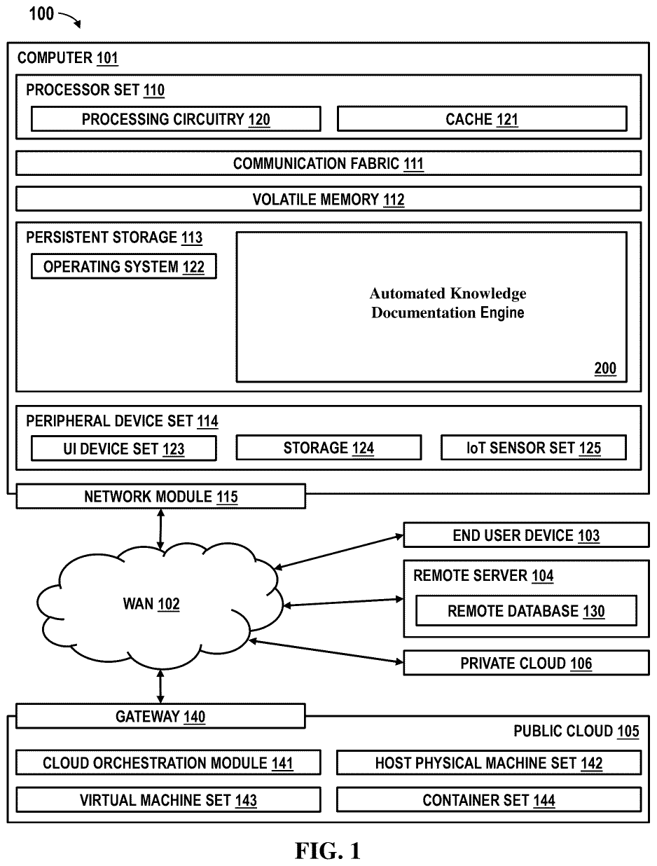

Now with reference to FIG. 1. FIG. 1 depicts Computing environment 100. Computing environment 100 contains an example of an environment for the execution of at least some of the computer code involved in performing the inventive methods, such as automated knowledge documentation engine 200. In addition to automated knowledge documentation engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and automated knowledge documentation engine 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in automated knowledge documentation engine 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in automated knowledge documentation engine 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a large hybrid cloud.

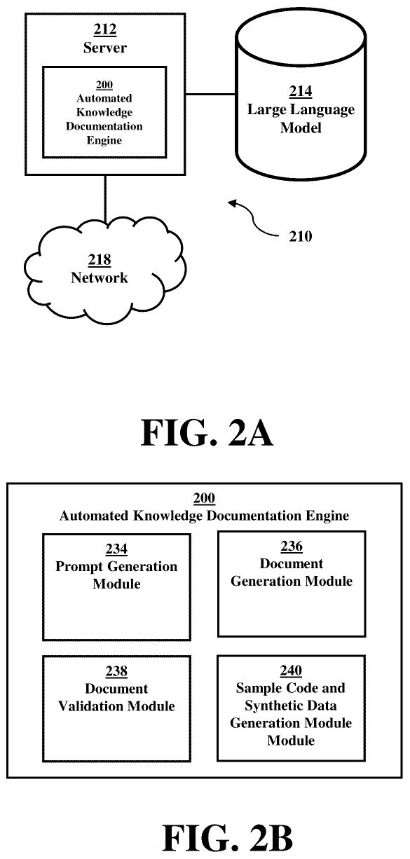

With reference now to FIG. 2A. FIG. 2A is a block diagram depicting system 210 for automated knowledge documentation of key performance indicators in industrial asset management. Shown in FIG. 2A, is automated knowledge documentation engine 200 operational on server 212. Shown connected to server 212 is large language model 214. The model may be locally operational on server 212 or operational over network 218 on a remote computational device (not depicted), where prompts and data are sent to the computational device running an instance of LLM 214 and responses are transmitted back to server 212 for utilization by automated knowledge documentation engine 200. It should be noted, while one LLM is shown via LLM 214, multiple LLMs may be utilized in an embodiment. For example, an LLM may incorporate domain knowledge, while a second LLM may be utilized for prompt generation in multi-turn question generation, while a third LLM may be used for generating a long-form knowledge document. Finally, a fourth LLM with domain knowledge may be used for inferencing and validating the long-form knowledge document. As seen in the immediately preceding example, four separate LLMs are utilized, however, this is not to be used in a limiting sense, as any number of LLMs may be utilized (e.g., 1, 2 . . . n, n+1).

With reference now to FIG. 2B. FIG. 2B is automated knowledge documentation engine 200. Automated knowledge documentation engine 200 is a framework that can generate tailored knowledge documents from a large language model for asset management, without the input of a subject matter expert. In an embodiment, Automated knowledge documentation engine 200 is configured in an AI agentic architecture. Shown operational on automated knowledge documentation engine 200 is multi-turn question generation module 234, document generation module 236, document validation module 238, and Sample Code and Synthetic Data Generation Module 240.

Multi-turn question generation module 234 is a computer module that can generate a series of prompts. In an embodiment, Multi-turn question generation module 234 can be a pretrained LLM with a system prompt. In the LLM, a system prompt in an LLM is an instruction that defines the LLM's role, response style, and constraints, ensuring it provides relevant, accurate, and safe answers while adhering to specific guidelines. The system prompt may read as follows:
“You are a helpful, respectful, and honest assistant. Always provide clear, accurate, and useful responses while ensuring safety, reliability, and ethical integrity. Please ensure that your responses are socially unbiased and positive in nature. Do not include any specific company contact information. I want to know the factors that impact industrial asset health, which will be used for knowledge extraction for the asset health score calculation. Examples of asset types include but are not limited to turbines, electrical transformers, and compressors. The aspects that impact asset health typically come from the following four groups: a) asset component quality and its health, b) maintenance, failure, and repair history, also the alert and anomaly history; and c) asset age. We only focus on one aspect for each chat session. In the process, you should play the roles as: Domain expert for the specific industrial asset {asset_class} to provide the knowledge for factors of impacts on the asset health.”
   The above prompt may be part of a multi-turn question system prompt in which the goal is to extract knowledge from an LLM to generate a long-form knowledge document including a health score for any industrial asset.

Multi-turn question generation module 234 is a computer module that can generate one or more prompts to extract domain knowledge with a hierarchy format relating to an asset. In an embodiment, multi-turn question generation module 234 can generate prompts and questions iteratively in a multi-turn question format. The generated prompts can be input into LLM 214 (using automated knowledge documentation engine 200) to extract knowledge relating to an assets KPIs and key metrics. The extracted knowledge can be in the form of answers to the prompt generated by LLM 214. For example, the multi-turn question prompts can be generated by multi-turn question generation module 234 in the following manner:
Questions=“““Let us focus on the asset component quality and health first. We are interested in the factors coming from the 1. Mechanic; 2. Electrical, 3. Thermal, and 4. Chemical quality issues for the asset health: if there is insulation, please include the quality of the oil insulation. Can you give me detailed guidelines for identifying factors impacting overall asset health?”””
“““Great, this answer is an excellent general guideline. Let's focus on a specific asset type: {asset_class}. I need your help to identify the factors that indicate the deterioration of the {asset_class}'s component quality, and those factors should be able to be monitored and quantified in the future. Please do not include routing operational and pollution factors in the answers. However, performance efficiency deterioration, part teardown, noise, and leakage etc. could be included if relevant. Do not include any specific company contact information.”””,
“““We need the factors be very specific for asset type {asset_class}. Here is detailed explanation: {asset_description}”””,
“““What sensor could be used to check such quality deterioration?”””,
“““Please help me export a markdown output as guidelines for analyzing the quality of asset component health or quality to overall asset health, the output has three sections: First part, an introduction with a level 2 heading. It is the beginning part of the document, please briefly introduce the {asset_class}, its usage in the various application and also include the introduction of its components as a markdown table at the same section. Second part, an overview of the factors that indicating the health quality such as the deterioration of the {asset_class}'s component. Give a table of key factors of such quality deterioration and possible causes. Finally, the third part, a highlight the sensors being able to use measure such components quality or its quality deterioration. Please output as a markdown table, each row contains columns of a) the quality problem monitored; b) possible sensor(s) used; and c) the reason of using such sensor(s).”””,
“““Generate better response in terms of readability, accuracy, and completeness. Please help me export a markdown output as guidelines for analyzing the quality of asset component health or quality to overall asset health, the output has three sections: First part, an introduction with a level 2 heading. It is the beginning part of the document, please briefly introduce the {asset_class}, its usage in the various application and also include the introduction of its components as a markdown table at the same section. Second part, an overview of the factors that indicating the health quality such as the deterioration of the {asset_class}'s component. Give a table of key factors that contribute to such quality deterioration and possible causes. Finally, the third part, a highlight the sensors being able to use measure such components quality or its quality deterioration. Please output as a markdown table, each row contains columns of a) the quality problem monitored; b) possible sensor(s) used; and c) the reason of using such sensor(s).”””,
“““Generate better response in terms of readability, accuracy, and completeness. Please help me export a markdown output as guidelines for analyzing the quality of asset component health or quality to overall asset health, the output has three sections: First part, an introduction with a level 2 heading. It is the beginning part of the document, please briefly introduce the {asset_class}, its usage in the various application and also include the introduction of its components as a markdown table at the same section. The second part, an overview of the factors that indicating the health quality such as the deterioration of the {asset_class}'s component. Give a table of key factors of such quality deterioration and possible causes. Finally, the third part, a highlight the sensors being able to use measure such components quality or its quality deterioration. Please output as a markdown table, each row contains columns of a) the quality problem monitored; b) possible sensor(s) used; and c) the reason of using such sensor(s).”””

In another embodiment, multi-turn question generation module 234 may utilize a knowledge taxonomy graph to auto generate questions. For example, a knowledge taxonomy graph which contains a hierarchy of the taxonomy of an asset which can be parsed and utilized by multi-turn question generation module 234 to generate a sequence of questions for knowledge extraction regarding an asset in question. For example, in an asset health analysis, may analyze three items which are the highest level of the taxonomy. These items may be component quality, the historical record, and asset profile. Drilling down into the component quality hierarchy, the next level of the hierarchy many be the items which impact component quality, such as mechanical health issues, thermal health issues, electrical issues, and chemical health issues (these issues may be annotated by the asset type as they may affect assets differently). Drilling down a level further in the hierarchy, these assets may be measured by on-demand inspection, continuous sensors, or periodic chemical sampling. These connections may be associated with a weight that varies depending on the asset type and position within the overarching process that is accomplished by the system which the asset participates.

Document generation module 236 is a computer module that can receive the output (i.e., answers) of LLM 214 when the input is the questions generated by Multi-turn question generation module 234. Document generation module can parse the output, identify the KPIs and/or key metrics, and organize the identified KPIs into a long-form knowledge document. For example, multiple answers may be output relating to the KPIs of a closed-loop water-cooler chiller. Document generation module 236 may organize the answers by section, where the sections may be “Introduction to Closed-loop Water Cooled Chiller” where the introduction describes what the asset is and what function it performs. The next sections may be “factors indicating health quality deterioration”, risk factors for a closed-loop water cooler chiller, and quantifying the risk factors for a closed-loop water cooler.

In an embodiment, document generation module 236 may identify gaps within the extracted knowledge, that are required to generate a satisfactory long-form knowledge document. For example, key gaps may exist. These key gaps may be related to manual knowledge transfer to the LLM, where delays in knowledge transfer may be associated with subject (i.e. domain) matter expertise. There may also be key gaps due to limited automation, where raw data is required to be converted into KPIs for accurate output. There may also be integration challenges, in which there is difficulty aligning evolving asset date with existing KPI models. Gaps may also exist within high-level KPIs (e.g., health, performance, cost, etc. ...). This can be due to KPIs requiring complex models to integrate data and context. Additionally, gaps may exist in lower-level data (e.g., sensors and alerts) where raw data of sensor data requires extensive processing or where real-time data lacks direct actionable insights.

Document validation module 238 is a computer module that can receive the long-form knowledge document and validate the information within the document. For example, document validation module 238 can receive the long-form knowledge document and partition the document into sections or paragraphs based on a natural language model. In an embodiment, document validation module 238 can generate three claims regarding the partition. In this context, claims refer to specific assertions or conclusions derived from the partition or passage. These three claims are generated by a separate LLM process, which takes the partition as input and deduce them based on a system prompt. For example, document validation module 238 can parse the partition and generate three claims using a one-shot method. Further Document validation module 238 can generate claims using an LLM with a build in system prompt, where the system prompt may be as follows:

### Prompt Example 1

System Propmt: Read the passage, and generate three claims that are supported by the passage. Please do not generate any additional claims that are not supported by the passage. Passage: A substation electrical transformer is a large electrical device that changes the voltage of electricity. It is a crucial component in the electrical power system, used to step up or step down the voltage of electricity for transmission and distribution. Substation electrical transformers are used in various applications, such as power transmission and distribution, industrial processes, and commercial buildings.
The main components of a substation electrical transformer include the core, windings, insulation, oil, and cooling system. The core is made up of thin laminations of steel, which are stacked together to form the magnetic circuit. The windings are the conductors that carry the electrical current, and are insulated from each other and the core to prevent short circuits. The insulation is typically made of paper or oil-impregnated pressboard, and is used to insulate the windings from each other and the core. The oil serves as both a coolant and insulator, and helps to prevent the transformer from overheating. The cooling system is used to remove the heat generated by the transformer during operation. Please use (Internal thought).
(Internal thought). first, I will read the given passage and understand it. Then, I will generate three claims that are supported by given passage.

Claims can be generated by multi-turn question generation module 234 based on the prompt, for example the following claims may be generated based on Prompt example.
Answer: here are three claims.
First Claim: Substation electrical transformers are essential for stepping up or stepping down the voltage of electricity to match the requirements of different parts of the power grid.
Second Claim: The core of a substation electrical transformer is made up of thin laminations of steel that are stacked together to form a magnetic circuit.
Third Claim: The insulation used in a substation electrical transformer must be able to withstand high temperatures and provide electrical insulation between the windings and the core.
Finally, I have completed generating three claims [TOKENSTOP]

Further, document validation module 238 can perform an internet search to obtain a number (e.g., 10, 20, 30). For example, document validation module 238 can input the generated claims into a search engine (e.g., Duckduckgo®, Google®, Microsoft Bing®, Yahoo®, etc. . . . ). Document validation module 238 can break down the articles into a smaller format (e.g., paragraph, sentence) and identify via natural language inferencing whether the claim is valid. In other words, it checks to see if any portion of the claim is supported via evidence in the article pieces.

In another embodiment, document validation module 238 can follow a reference generation pipeline algorithm. For example, the Algorithm depicted in table 2:

Algorithm 1 Reference Generator pipeline

| | |
|---|---|
| 1: | Input: Knowledge Document kd, Web Corpus D |
| 2: | Output: Set of passages with citations S = {p₁, p₂, ..., pₙ} |
| 3: | Split kd into passages p₁, p₂, ..., Pₙ |
| 4: | for each passage pᵢ do |
| 5: | Generate sub-claims claim1ᵢ, claim2ᵢ, claim3ᵢ, using LLM |
| 6: | for each claim1ᵢ, claim2ᵢ, claim3i, do |
| 7: | Query the web corpus D using claimⱼ |
| 8: | Fetch relevant web documents |
| 9: | Extract web passages d_{i,j} from web document |
| 10: | Verify factual alignment of d_{i,j} with claimⱼ using NLI model |
| | (e.g., TRUE) |
| 11: | if factual alignment score is high then |
| 12: | retain d_{i,j} as valid source for pᵢ |
| 13: | else |
| 14: | Discard d_{i,j} |
| 15: | end if |
| 16: | end for |
| 17: | end for |
| 18: | Apply iterative quality assurance to improve references |
| 19: | for each passage pᵢ do |
| 20: | if confidence score of citation is below threshold then |
| 21: | Re-query web or adjust claim |
| 22: | end if |
| 23: | end for |
| 24: | Compile final set of passages S with citations |
| 25: | Return S = {p₁, P₂, ..., Pₙ} with citations |

In another embodiment, sample code and synthetic data generation module 240 can receive the validated long-form knowledge document and further utilized this documentation for synthetic data generation and the KPI calculation code using LLM using the simple weighted approach or AHP approach, where the system prompt may be as follows:

### Prompt Example 2

System Propmt: You are an expert data scientist specializing in industrial health asset analysis and KPI evaluation. Based on the user's input, you will generate KPI calculation Python code using both the weighted approach and the Analytic Hierarchy Process (AHP) approach. You will also generate high-quality synthetic test data that aligns with industrial health asset information, ensuring it accurately reflects real-world conditions. Your outputs must be accurate, reliable, and adhere to best practices in data science. Structure your responses for clarity, ease of integration, and scalability in industrial health asset management applications.

Also shown operational on an automated knowledge documentation engine 200 is sample code and synthetic data generation module 240 is a computer module that can generate a KPI calculation code using a weighted approach or the Analytic Hierarchy Process (AHP) approach, along with synthetic test data generated by the LLM.

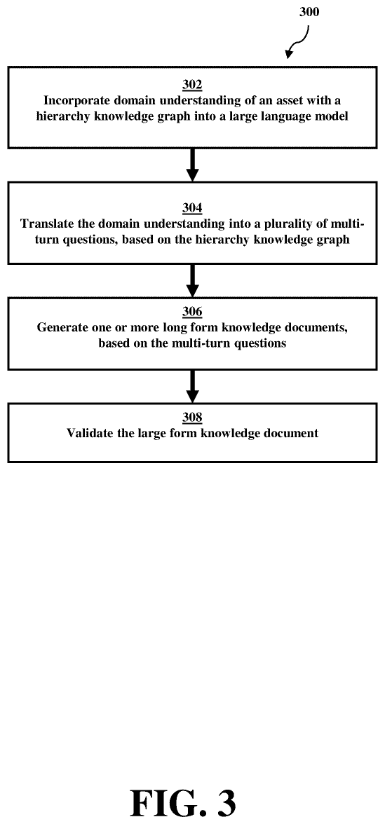

With reference now to FIG. 3. FIG. 3 is a flowchart 300 depicting the steps of automated knowledge documentation of key performance indicators. At step 302, incorporate domain understanding of an asset with hierarchy structure into a large language model. For example, knowledge integration module 232 can impart data associated with an asset that into an LLM such as LLM 214.

At step 304, translate the domain understanding into a plurality of multi-turn questions. For example, multi-turn question generation module 234 can explore the data imparted or incorporated into LLM 214 via generating questions with an LLM. In this example, multi-turn question generation module 234 can iteratively generate questions via an immutable or dynamic prompt. The questions can be fed into LLM 214 to generate knowledge in LLM 214 for a predetermined number of rounds, or until a confidence score is reached, where the confidence score represents a satisfactory knowledge generation with minimal knowledge gaps regarding the asset.

At step 306, document generation module 236 can generate a long-form knowledge document for the asset in question from the answers extracted by multi-turn generation module 234. For example, document generation module 236 can receive the output (i.e., answers) from multi-turn generation module 234. Document generation module 236 can parse the answers and generate a document which identifies the key performance indicators associated with an asset. The document generated can be dynamically generated including the format of the document, or it can be generated where the KPIs class and associated details are preformatted (e.g., with headings associated with the KPIs and details of said KPIs in table format). In an embodiment, validation module 238 generates a validated document, which serves as the foundation for Sample Code and Synthetic Data Generation Module 240. Based on this validated document, module 240 generates the KPI calculation code using a weighted approach or the Analytic Hierarchy Process (AHP) approach, along with synthetic test data.

At step 308, document validation module 238 can validate the long-form knowledge document. For example, document validation module 238 can receive the long-form knowledge document generated by document generation module 236 and verify or validate the information in the long-form knowledge document. In an embodiment, document validation module can partition the long-form knowledge document into separate portions. A number of claims (e.g., 2, 3, 4 . . . etc) can be generated for each partition. The claims can be factual statements generated by an LLM based on the partition. In an embodiment, document generation module 236 claims perform an internet search of each of the claims to determine whether there are unrelated or third-party (e.g., external sources or verified references) factual statements on the internet which back up the veracity of the claims. If document validation module 238 analyzes the search results and finds data which corresponds to the claims, the claims are verified, and that portion of the knowledge document is validated. In an example, portions of the document which are not validated can be presented to a user for further refinement or returned to multi-turn question generation module for another iteration and fine-tuning of the system.

According to an embodiment of the present invention a computer-implemented method for automated documentation of key performance indicators may be disclosed. The computer-implemented method may comprise incorporating domain understanding of an asset with a hierarchy into a large language model. The computer-implemented method may further comprise translating the domain understanding into a plurality of multi-turn questions annotated with the asset profile utilizing the large language model. The computer-implemented method may comprise generating one or more long-form knowledge documents, based on the multi-turn questions, wherein the long-form knowledge document comprises key performance indicators for the asset. The computer-implemented method may comprise validating, by the processor, the large form knowledge document, utilizing a natural language inferencing model. The question of next-turn further utilizes the response of previous question answer to refine the next question.

In an embodiment, validating a generated document may comprise partitioning the validated long-form knowledge document into a plurality of partitions and generating a plurality of claims for each partition utilizing the large language model.

In an embodiment, the present invention may further comprise retrieving a plurality of third-part accessible articles for each of the plurality of claims and dividing each of the retrieved articles into paragraphs.

In an embodiment, the present invention may further comprise determining if a claim is true based on any supporting from the plurality of retrieved articles. In the embodiment, if responsive to a determination of the claim being true, validating the claim as evidence-backed claim from one or more third-party accessible articles.

In an embodiment, domain understanding of an asset is associated with one or more of the following: the quality of components that comprise the asset, asset historical record, and/or asset profile.

In an embodiment, KPI-specific hierarchy is based on one or more annotations associated with an asset description as knowledge graph within an annotation by industrial asset type. The knowledge graph captures the information gathering flow from lower-level or detailed measures to a high-level KPI.

In an embodiment, retrieving a plurality of articles may comprise performing an internet search or preharvest articles, based on the three claims, wherein at least 20 articles are retrieved.

In an embodiment, key performance indicators are one or more of the following: health score, sustainability score, asset reliability, maintenance costs, asset availability, performance efficiency, reliability score, and/or criticality score or other critical score associated the business value of the industrial asset.

In an embodiment, the health score reflects a current physical condition and a current performance of an asset operation.

In an embodiment, the asset is one of the following: a wind turbine, a substation electrical transformer, a water-cooled condenser, turbine generator, industrial boiler, industrial oven, industrial furnace, centrifugal compressor, hydraulic press, steam turbine and other industrial asset types.

According to an embodiment of the present invention, a computer system for automated documentation of key performance indicators may be disclosed. The computer system may comprise a processor, a computer readable storage medium, program instruction stored on the computer readable storage medium, where the program instructions are executable by the processor and cause the processor to perform one or more operations. The one or more operations comprising incorporate domain understanding of an asset with a hierarchy into a large language model. Also, operations to translate the domain understanding into a plurality of multi-turn questions annotated with the asset profile utilizing the large language model. Additionally, operations to generate one or more long-form knowledge documents, based on the multi-turn questions, wherein the long-form knowledge document comprises key performance indicators for the asset and operations to validate the large form knowledge document, utilizing a natural language inferencing model. The question of next-turn further utilizes the response of previous question answer to refine the next question.

In an embodiment, validating may further comprise operations to partition the validated long-form knowledge document into a plurality of partitions and generate a plurality of claims for each partition utilizing the large language model.

An embodiment may further comprise operations to retrieve a plurality of third-part accessible articles for each of the plurality of claims and divide each of the retrieved articles into paragraphs.

An embodiment may further comprise operations to determine if a claim is true based on any supporting from the plurality of retrieved articles. If responsive to a determination of the claim being true, operations to validate the claim as evidence-backed claim.

In an embodiment, the domain understanding of an asset is associated with one or more of the following: the quality of components that comprise the asset, asset historical record, and/or asset profile.

According to an embodiment of the present invention a computer program product for automated documentation of key performance indicators may be disclosed. The computer program product may comprise program instructions stored on a computer readable storage medium. The program instructions can be executable by a processor to perform one or more operations. The computer program product may comprise program instructions to incorporate domain understanding of an asset with a hierarchy into a large language model. The computer program product may also comprise program instructions to translate the domain understanding into a plurality of multi-turn questions annotated with the asset profile utilizing the large language model. The computer program product may additionally comprise program instructions to generate one or more long-form knowledge documents, based on the multi-turn questions, wherein the long-form knowledge document comprises key performance indicators for the asset. Whilst the computer program product may comprise program instructions to validate the large form knowledge document, utilizing a natural language inferencing model.

In an embodiment, validating may comprise program instructions to partition the validated long-form knowledge document into a plurality of partitions and program instructions to generate a plurality of claims for each partition utilizing the large language model.

An embodiment may further comprise program instructions to retrieve a plurality of third-part accessible articles for each of the plurality of claims and program instructions to divide each of the retrieved articles into paragraphs.

An embodiment may further comprise program instructions to determine if a claim is true based on any supporting from the plurality of retrieved articles. If responsive to a determination of the claim being true, the embodiment may comprise program instructions to validate the claim as evidence-backed claim.

In an embodiment, the domain understanding of an asset is associated with one or more of the following: the quality of components that comprise the asset, asset historical record, and/or asset profile.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for automated documentation of key performance indicators, the computer-implemented method comprising:
incorporating, by a processor, domain understanding of an asset with a hierarchy into a large language model;
translating, by the processor, the domain understanding into a plurality of multi-turn questions annotated with an asset profile utilizing the large language model;
generating, by the processor, one or more long-form knowledge documents, based on the multi-turn questions, wherein the one or more long-form knowledge documents include key performance indicators for the asset; and
validating, by the processor, the one or more long-form knowledge documents, utilizing a natural language inferencing model.

2. The computer-implemented method of claim 1, wherein validating comprises:
partitioning the one or more long-form knowledge documents into a plurality of partitions; and
generating a plurality of claims for each partition utilizing the large language model.

3. The computer-implemented method of claim 2, further comprising:
retrieving a plurality of articles accessible to third parties for each claim of the plurality of claims; and
dividing each article of the plurality of articles into paragraphs.

4. The computer-implemented method of claim 3, further comprising:
determining if a first claim is true based on support from any article of the plurality of retrieved articles; and
responsive to a determination of the first claim being true, validating the first claim as an evidence-backed claim.

5. The computer-implemented method of claim 3, wherein retrieving the plurality of articles comprises:
performing an internet search for preharvest articles, based on the plurality of claims, wherein at least 20 articles are retrieved.

6. The computer-implemented method of claim 1, wherein the domain understanding of the asset is associated with one or more of the following: quality of components that comprise the asset, an asset historical record, and/or the asset profile.

7. The computer-implemented method of claim 1, wherein the hierarchy is based on one or more annotations associated with an asset description as a knowledge graph within an annotation by industrial asset type.

8. The computer-implemented method of claim 1, wherein the key performance indicators are one or more of the following: health score, sustainability score, asset reliability, maintenance costs, asset availability, performance efficiency, reliability score, and/or criticality score.

9. The computer-implemented method of claim 8, wherein the health score reflects a current physical condition and a current performance of an operation of the asset.

10. The computer-implemented method of claim 1, wherein the asset is one of the following industrial asset types: a wind turbine, a substation electrical transformer, a water-cooled condenser, a turbine generator, an industrial boiler, an industrial oven, an industrial furnace, a centrifugal compressor, a hydraulic press, and a steam turbine.

11. A computer system for automated documentation of key performance indicators, the computer system comprising:
a processor;
a computer readable storage medium; and
program instruction stored on the computer readable storage medium, wherein the program instructions are executable by the processor and cause the processor to perform one or more operations, the one or more operations comprising:
incorporate domain understanding of an asset with a hierarchy into a large language model;
translate the domain understanding into a plurality of multi-turn questions annotated with an asset profile utilizing the large language model;
generate one or more long-form knowledge documents, based on the multi-turn questions, wherein the one or more long-form knowledge documents comprise key performance indicators for the asset; and
validate the large form knowledge document, utilizing a natural language inferencing model.

12. The computer system of claim 11, wherein validating further comprises operations to:
partition the one or more long-form knowledge documents into a plurality of partitions; and
generate a plurality of claims for each partition utilizing the large language model.

13. The computer system of claim 12, further comprising operations to:
retrieve a plurality of articles accessible to third parties for each claim of the plurality of claims; and
divide each article of the plurality of articles into paragraphs.

14. The computer system of claim 13, further comprising operations to:
determine if a first claim is true based on support from any article of the plurality of retrieved articles; and
responsive to a determination of the first claim being true, validate the first claim as an evidence-backed claim.

15. The computer system of claim 11, wherein the domain understanding of the asset is associated with one or more of the following: quality of components that comprise the asset, an asset historical record, and/or the asset profile.

16. A computer program product for automated documentation of key performance indicators, the computer program product comprising program instructions stored on a computer readable storage medium, wherein the program instructions can be executable by a processor to perform one or more operations, wherein the computer program product comprises:
program instructions to incorporate domain understanding of an asset with a hierarchy into a large language model;
program instructions to translate the domain understanding into a plurality of multi-turn questions annotated with an asset profile utilizing the large language model;
program instructions to generate one or more long-form knowledge documents, based on the multi-turn questions, wherein the one or more long-form knowledge documents comprise key performance indicators for the asset; and
program instructions to validate the large form knowledge document, utilizing a natural language inferencing model.

17. The computer program product of claim 16, wherein validating further comprises:
program instructions to partition the one or more long-form knowledge documents into a plurality of partitions; and
program instructions to generate a plurality of claims for each partition utilizing the large language model.

18. The computer program product of claim 17, further comprising:
program instructions to retrieve a plurality of articles accessible to third parties for each claim of the plurality of claims; and
program instructions to divide each article of the plurality of articles into paragraphs.

19. The computer program product of claim 18, further comprising:
program instructions to determine if a first claim is true based on support from any article of the plurality of retrieved articles; and
responsive to a determination of the first claim being true, program instructions to validate the first claim as an evidence-backed claim.

20. The computer program product of claim 16, wherein the domain understanding of the asset is associated with one or more of the following: quality of components that comprise the asset, an asset historical record, and/or the asset profile.
